(19) United States
(12) Patent Application Publication
(10) Pub. No.: US 2026/0274135 A1
(43) Pub. Date: Sep. 17, 2026

(54) CONVEYANCE SEAT

(71) Applicants: TS TECH CO., LTD., Asaka-shi, Saitama (JP); ALPS ALPINE CO., LTD., Ota-ku, Tokyo (JP)

(72) Inventors: Nobuyuki TEZUKA, Tochigi (JP); Kazuki KOBAYASHI, Tochigi (JP); Satoshi KOGURE, Tokyo (JP); Ryo ITO, Tokyo (JP)

(21) Appl. No.: 18/868,520

(22) PCT Filed: May 23, 2023
(86) PCT No.: PCT/JP2023/019226

§ 371 Date: Nov. 22, 2024

Related U.S. Application Data
(60) Provisional application No. 63/345,131, filed on May 24, 2022.

(51) Int. Cl. B60N 2/879; B60N 2/56; B60N 2/809

(52) U.S. Cl. CPC B60N 2/879; B60N 2/5657; B60N 2/809

(57) ABSTRACT

A conveyance seat that allows microphones to suitably collect sound output by speakers includes a headrest; right and left speakers provided inside the headrest; and right and left microphones provided inside the headrest. The microphones are disposed at positions below the speakers, and are disposed to protrude further toward a front side than the speakers. The microphones are disposed such that sound collection portions of the microphones face upward toward the speakers.

### TECHNICAL FIELD

The present invention relates to a conveyance seat, particularly to a conveyance seat including a headrest and a speaker provided inside the headrest.

### BACKGROUND ART

In the related art, a conveyance seat in which speakers (acoustic devices) are installed inside a headrest has been known (for example, refer to PATENT LITERATURES 1 and 2).

PATENT LITERATURE 1 discloses a headrest including right and left speakers and a speaker assembly for assembling the right and left speakers.

The speaker assembly includes right and left speaker holding portions (enclosures) that hold the right and left speakers, respectively, in a state where the right and left speakers are exposed to a seat front side, and a connecting portion (connecting plate) that connects the right and left speaker holding portions. The right and left speaker holding portions are assembled to the connecting portion by assembly bolts. In addition, the speaker assembly is attached to the headrest (headrest pillar) via an attachment plate.

In addition, PATENT LITERATURE 2 discloses a headrest including an acoustic system.

Specifically, the acoustic system includes a speaker that outputs sound toward a seated occupant; a plurality of microphones that pick up sound around the seated occupant; and noise control means that controls noise in response to the sound picked up by the microphones.

### CITATION LIST

### Patent Literature

PATENT LITERATURE 1: JP 2017-525456 A
PATENT LITERATURE 2: JP 2007-3994 A

### SUMMARY OF INVENTION

### Technical Problem

By the way, in the headrest in which the speakers and the microphones are installed as in PATENT LITERATURES 1 and 2, there has been a demand for technology that allows the microphones to suitably collect sound output by the speakers. In addition, since the internal structure of the headrest is complicated, there has been a demand for a solution to simply assemble the speakers and the microphones to the headrest (headrest pillar).

The present invention has been made in view of the above-described problems, and an object of the present invention is to provide a conveyance seat in which speakers and microphones are installed, and which allows the microphones to more suitably collect sound output by the speakers than in the related art.

In addition, another object of the present invention is to provide a conveyance seat that allows speakers and microphones to be more simply assembled to a headrest than in the related art.

### Solution to Problem

The problems are solved by a conveyance seat of the present invention including: a headrest; right and left speakers provided inside the headrest; and right and left microphones provided inside the headrest. The microphones are disposed at positions below the speakers, and are disposed to protrude further toward a front side than the speakers, and the microphones are disposed such that sound collection portions of the microphones face upward toward the speakers.

With the above-described configuration, inside the headrest, the microphones are disposed below the speakers, and are disposed to protrude further toward the front side than the speakers, and the sound collection portions of the microphones face upward toward the speakers. For that reason, the conveyance seat that allows the microphones to suitably collect sound output by the speakers can be realized.

In this case, it is preferable that a front cover disposed to cover the right and left speakers and the right and left microphones from a front is provided, and it is preferable that the right and left microphones are disposed at positions closer to an outside in a seat width direction than the right and left speakers.

As described above, the microphones protruding further forward than the speakers are disposed at positions closer to the outside in the seat width direction than the speakers. For that reason, a front cover can suitably support the head of a seated occupant (discomfort felt by the seated occupant due to the microphones is suppressed).

In this case, it is preferable that a front cover disposed to cover the right and left speakers and the right and left microphones from a front is provided, it is preferable that the front cover includes a cover central portion provided at a central portion of the front cover in a seat width direction, and right and left cover side portions disposed outside the cover central portion in the seat width direction, and protruding further forward than the cover central portion, and it is preferable that a partition wall portion between the cover central portion and each of the cover side portions is disposed at a position overlapping the microphone in an up to down direction and a front to rear direction.

With the above-described configuration, the microphones can be suitably disposed on the front cover (cover side portions), and an increase in the size of the front cover can be suppressed. Namely, the speakers and the microphones can be simply assembled to the headrest.

In this case, it is preferable that a pillar that supports a main body of the headrest, and a speaker assembly provided inside the headrest and configured to assemble the right and left speakers and the right and left microphones are provided, it is preferable that the speaker assembly includes accommodation recesses for accommodating the microphones, it is preferable that the accommodation recesses protrude further forward than the pillar, and it is preferable that the microphones are disposed at positions closer to an outside in a seat width direction than the speakers.

As described above, by disposing the microphones at positions closer to the outside in the seat width direction than the speakers, discomfort felt by the seated occupant due to the microphones is suppressed.

In addition, the speakers and the microphones can be simply assembled to the headrest.

In this case, it is preferable that a speaker assembly provided inside the headrest and configured to assemble the right and left speakers, and the right and left microphones and a front cover disposed to cover the right and left speakers, the right and left microphones, and the speaker assembly from a front are provided, it is preferable that the speaker assembly includes right and left speaker holding portions that hold the right and left speakers and the right and left microphones, respectively, and a connecting portion that connects the right and left speaker holding portions, it is preferable that each of the speaker holding portions includes an accommodation recess for accommodating the microphone, it is preferable that an overlapping portion of the front cover that overlaps the accommodation recess in a front view is disposed to incline inward or outward in a seat width direction, it is preferable that a front surface of the accommodation recess is disposed to incline in the same direction as the overlapping portion of the front cover, and it is preferable that the microphone is accommodated in the accommodation recess in a state where the microphone is inclined in the same direction as the front surface of the accommodation recess.

With the above-described configuration, interference of the microphones (front end portions of the microphones) with the front cover can be suppressed.

In addition, the speakers and the microphones can be simply assembled to the headrest.

In this case, it is preferable that the overlapping portion of the front cover is disposed to incline inward in the seat width direction, it is preferable that the front surface of the accommodation recess is disposed to incline in the same direction as the overlapping portion of the front cover, and it is preferable that the microphone is accommodated in the accommodation recess in a state where the microphone is inclined in the same direction as the front surface of the accommodation recess.

In addition, it is preferable that the microphone is accommodated in the accommodation recess in a state where the microphone is inclined further inward in the seat width direction than the front surface of the accommodation recess.

With the above-described configuration, the microphones can be suitably disposed to incline inward in the seat width direction (to incline toward a seated occupant side).

In this case, it is preferable that a recessed portion recessed rearward is formed on the front surface of the accommodation recess, and it is preferable that a rear portion of the microphone is accommodated in the recessed portion.

With the above-described configuration, the amount of forward protrusion of the microphones can be adjusted by the recessed portions.

In this case, it is preferable that the front cover includes a cover central portion provided at a central portion of the front cover in the seat width direction, and right and left cover side portions disposed outside the cover central portion in the seat width direction, and protruding further forward than the cover central portion, and it is preferable that the cover side portions cover at least parts of the speaker holding portions from the front and both sides in the seat width direction.

In addition, it is preferable that each of the speaker holding portions includes a central wall portion forming the front surface of the accommodation recess, and a side wall portion protruding forward from an end portion of the central wall portion in the seat width direction, and it is preferable that the cover side portions cover at least the side wall portions of the speaker holding portions from the front and both the sides in the seat width direction.

As described above, since the cover side portions cover the speaker holding portions from the front and both the sides in the seat width direction, the speakers and the microphones accommodated in the accommodation recesses can be suitably covered. For example, sound output from the speakers can be suitably collected by the microphones.

### Advantageous Effects of Invention

According to the present invention, the conveyance seat that allows the microphones to suitably collect sound output by the speakers can be realized.

In addition, according to the present invention, the front cover can suitably support the head of the seated occupant (discomfort felt by the seated occupant due to the microphones is suppressed).

In addition, according to the present invention, the speakers and the microphones can be simply assembled to the headrest.

In addition, according to the present invention, interference of the microphones (front end portions of the microphones) with the front cover can be suppressed.

In addition, according to the present invention, the microphones can be suitably disposed to incline inward in the seat width direction (to incline toward a seated occupant side).

In addition, according to the present invention, the amount of forward protrusion of the microphones can be adjusted by the recessed portions.

In addition, according to the present invention, the speakers and the microphones accommodated in the accommodation recesses can be suitably covered. For example, sound output from the speakers can be suitably collected by the microphones.

### BRIEF DESCRIPTION OF DRAWINGS

FIG. 1 is a perspective view of a conveyance seat of the present embodiment.

FIG. 2 is a horizontal cross-sectional view of a headrest, and is a view showing a cushion material and a skin material.

FIG. 3 is a perspective view of a seat frame and a blower device.

FIG. 4 is a front view of the seat frame and the blower device.

FIG. 5 is an exploded perspective view of a pillar, a front cover, a rear cover, and a lower cover.

FIG. 6 is an exploded perspective view of the pillar, the front cover, the rear cover, and the lower cover when viewed from a different angle.

FIG. 7 is an enlarged view of main portions of the front cover, and is a view showing an opening portion.

FIG. 8 is a front view of speakers, microphones, a speaker assembly, and the rear cover.

FIG. 9A is a view describing a routing of a harness.

FIG. 9B is a view showing a state where the harness is passed through the inside of the pillar.

FIG. 10 is a view showing a state where the harness is exposed from the inside of the pillar.

FIG. 11 is a cross-sectional view taken along line XI-XI of FIG. 8.

FIG. 12 is a cross-sectional view taken along line XII-XII of FIG. 8.

FIG. 13 is a cross-sectional view taken along line XIII-XIII of FIG. 8.

FIG. 14A is a view describing a conveyance seat manufacturing method 1.

FIG. 14B is a view showing a continuation of FIG. 14A.

FIG. 14C is a view showing a continuation of FIG. 14B.

FIG. 15A is a view describing a conveyance seat manufacturing method 2.

FIG. 15B is a view showing a continuation of FIG. 15A.

FIG. 15C is a view showing a continuation of FIG. 15B.

### DESCRIPTION OF EMBODIMENTS

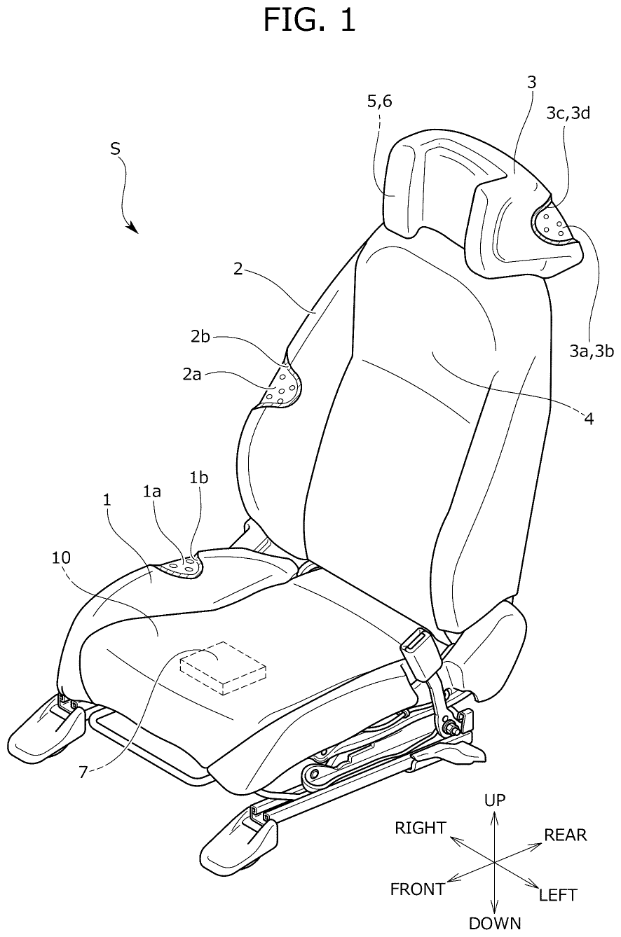

Hereinafter, an embodiment according to the present invention will be described with reference to FIGS. 1 to 15C.

The present embodiment relates to a “conveyance seat” that includes a headrest and right and left speakers and right and left microphones provided inside the headrest, and that allows the microphones to more suitably collect sound output by the speakers than in the related art.

Incidentally, a side on which a seated occupant is seated with respect to a seat back (headrest) of the conveyance seat is a seat front side.

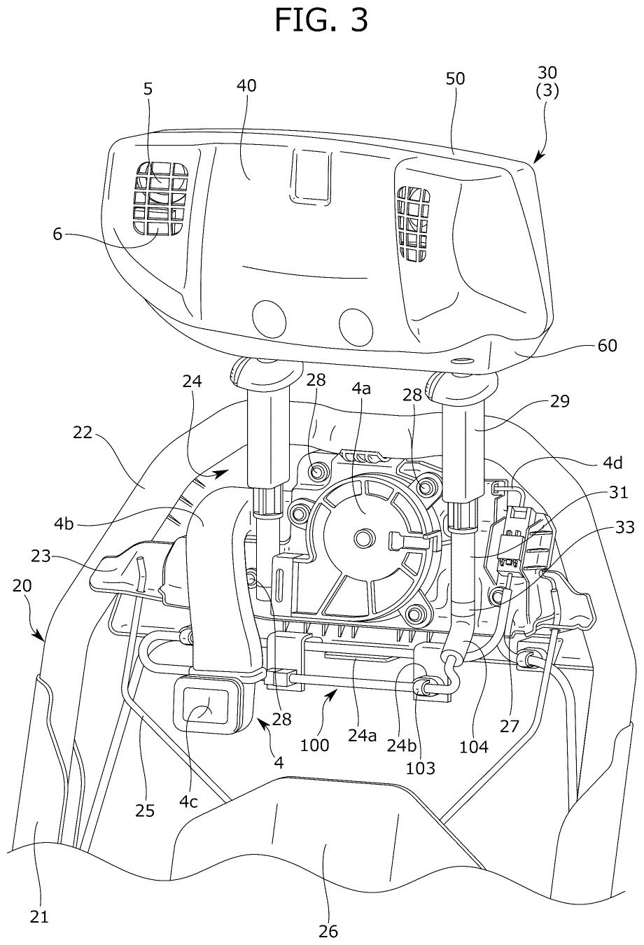

A conveyance seat S of the present embodiment is a vehicle seat as shown in FIG. 1, and includes a seat body including a seat cushion 1, a seat back 2, and a headrest 3, as shown in FIG. 3, a blower device 4 that is attached inside the seat back 2, and that blows air toward the seated occupant, speakers 5 that are attached inside the headrest 3, and that output sound toward the seated occupant, and microphones 6 that receive sound from the seated occupant or the outside to convert the sound into an electrical signal.

In addition, the conveyance seat S includes a control device 7 that is attached to the seat body, that is connected to the blower device 4, the speakers 5, and the microphones 6, and that controls the blower device 4, the speakers 5, and the microphones 6.

In addition, the conveyance seat S further includes a rail device that supports the seat body so as to be movable forward and rearward with respect to a vehicle body floor; a height link device that connects the seat body to the vehicle body floor so as to be raisable and lowerable; and a reclining device that rotatably connects the seat back 2 to the seat cushion 1.

As shown in FIG. 1, the seat cushion 1 is a seating portion that supports the seated occupant from below, and is mainly composed of a cushion frame 10 serving as a skeleton; a cushion material la placed on the cushion frame 10; and a skin material 1b that covers the cushion frame 10 and the cushion material la.

As shown in FIGS. 1 and 3, the seat back 2 is a backrest portion that supports the seated occupant from behind, and is mainly composed of a back frame 20 serving as a skeleton; a cushion material 2a; and a skin material 2b.

As shown in FIGS. 1 to 3, the headrest 3 is a head portion that supports the head of the occupant from behind, and is mainly composed of a headrest frame 30 serving as a skeleton; cushion materials 3a and 3b placed on the headrest frame 30; and skin materials 3c and 3d that cover the headrest frame 30 and the cushion materials 3a and 3b.

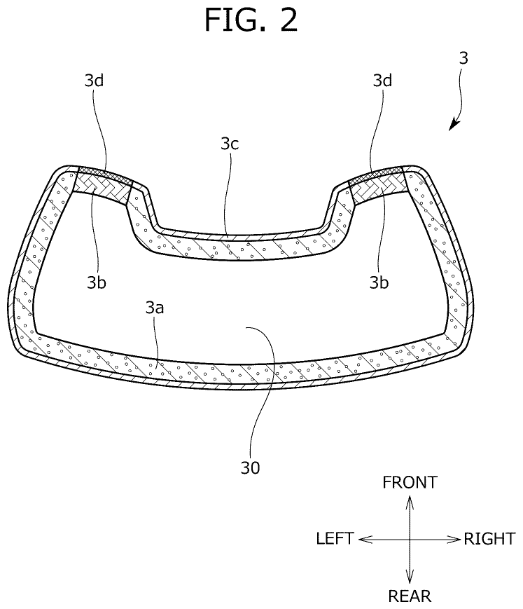

As shown in FIG. 2, the cushion material 3a is an elastic body made of an elastic material such as urethane.

The second cushion material 3b is a three-dimensional net-shaped elastic body formed from fibers intertwined in a three-dimensional shape. The second cushion material 3b has both the function of a cushion material and the function of transmitting sound output from the speakers 5.

Incidentally, the second cushion material 3b may be formed with higher acoustic transmission than the cushion material 3a, and is not limited to a three-dimensional net-shaped elastic body.

As shown in FIG. 2, the skin material 3c is a covering material made of a leather material having elasticity or the like.

The second skin material 3d is a covering material formed from fibers intertwined in a three-dimensional shape. The second skin material 3d has both the function of a covering material and the function of transmitting sound output from the speakers 5.

Incidentally, the second skin material 3d may be formed with higher acoustic transmission than the skin material 3c, and the configuration is not particularly limited.

In the above-described configuration, as shown in FIG. 2, cushion portions of the cushion material which correspond to the right and left speakers 5 and the right and left microphones 6 in a seat front to rear direction are the second cushion material 3b. The remaining cushion portion is the cushion material 3a.

In addition, skin portions of the skin material which correspond to the right and left speakers 5 and the right and left microphones 6 in the seat front to rear direction are the second skin material 3d. The remaining skin portion is the skin material 3c.

As a result, sound generated from the speakers 5 can be more efficiently transmitted to the outside. In addition, when the head of the seated occupant comes into contact with the headrest 3, causing discomfort to the seated occupant can be suppressed.

Incidentally, the cushion portions and the skin portions corresponding only to the speaker 5 may be the second cushion material 3b and the second skin material 3d, respectively.

Alternatively, the entire cushion material and the entire skin material of the headrest 3 may be the second cushion material 3b and the second skin material 3d, respectively.

### Blower Device, Speaker, Microphone, and Control Device

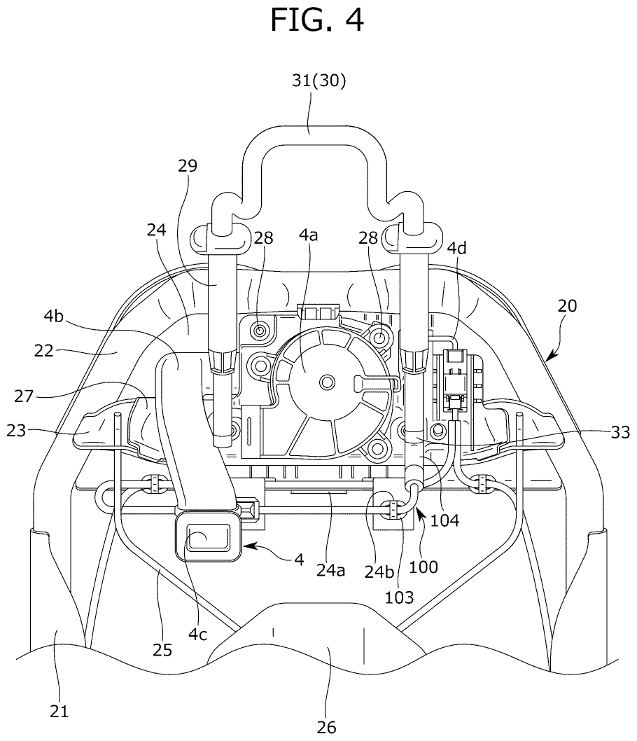

As shown in FIGS. 3 and 4, the blower device 4 is attached to a front surface of an upper portion of the back frame 20. Specifically, the blower device 4 is attached to front surfaces of a connecting frame 23 and a rear frame 24 of the back frame 20 via an attachment bracket 27.

The blower device 4 includes a blower body 4a that supplies air; a duct 4b through which the air passes; and a blower outlet 4c through which the air is blown toward the back of the seated occupant.

The blower body 4a is disposed at a central position of the upper portion of the back frame 20.

The duct 4b extends from the blower body 4a toward the outside (right side) in a seat width direction, bends to surround a pillar 31, and extends toward the seat front side.

The blower outlet 4c is formed at an extension end portion of the duct 4b.

Incidentally, the blower device 4 (blower body 4a) is connected to the control device 7 via a blower harness 4d. The blower harness 4d extends from the blower body 4a toward the outside (left side) in the seat width direction, bends to surround the pillar 31, and extends downward.

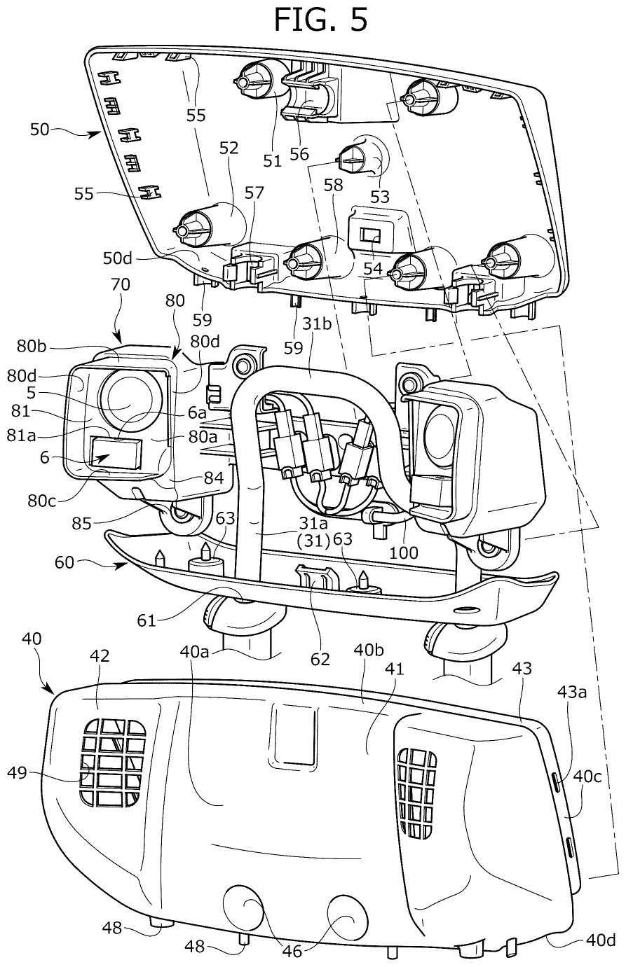

As shown in FIGS. 3 and 5, the speakers 5 are speaker units, are provided inside the headrest frame 30, and are disposed on right and left side portions of the headrest frame 30. Specifically, the speakers 5 are attached to the right and left of a front surface of a rear cover 50 of the headrest frame 30 via a speaker assembly 70.

The microphones 6 are microphone units, and similarly to the speakers 5, are disposed on the right and left side portions of the headrest frame 30, and are attached to the right and left via the speaker assembly 70.

As shown in FIG. 3 and FIGS. 8 to 10, the speakers 5 and the microphones 6 are connected to the control device 7 via speaker harnesses 100A and microphone harnesses 100B, respectively.

The harnesses 100A and 100B extend from the speakers 5 and the microphones 6 toward the inside in the seat width direction, respectively, and are bundled into a single harness 100, and the harness 100 passes through the inside of the pillar 31 (left pillar 31) and extends downward. Details will be described later.

As shown in FIG. 1, the control device 7 is a device that controls electrical components, and is attached to a bottom surface of the cushion frame 10 via a holder (not shown).

The control device 7 is electrically connected to the blower device 4 via the blower harness 4d and the harness 100. In addition, the control device 7 is electrically connected to the speakers 5 and the microphones 6 via the harness 100 (harnesses 100A and 100B). Incidentally, the control device 7 may be connected to these electrical components via wireless communication.

In addition, the control device 7 is also connected to a battery (not shown), and controls the battery to supply electricity to the blower device 4, the speakers 5, and the microphones 6.

The control device 7 is externally connected to, for example, an external terminal such as a tablet or a smartphone, a computer such as a PC, or an electrical device, and receives predetermined control signals (control information). Then, the control device 7 controls the drive of the blower device 4, the speakers 5, and the microphones 6 based on the control signals.

Incidentally, the control device 7 may be attached at a different location inside the conveyance seat S, or may be attached outside the conveyance seat S.

### Seat Frame

The cushion frame 10 is, although not shown in the figure, a substantially rectangular frame-shaped body, and is mainly composed of cushion side frames disposed on the right and left sides and extending in the seat front to rear direction; a pan frame that bridges front portions of the cushion side frames; a connecting frame that connects rear portions of the cushion side frames; and a plurality of elastic springs latched to the pan frame and the connecting frame and extending in a meandering manner in the seat front to rear direction.

Incidentally, in the present embodiment, the control device 7 is attached to the bottom surface of the cushion frame 10 (pan frame).

As shown in FIGS. 3 and 4, the back frame 20 is a substantially rectangular frame-shaped body, and includes side frames 21 disposed on the right and left sides and extending in an up to down direction; an upper frame 22 having an inverted U-shape that connects upper end portions of the side frames 21; a lower frame (not shown) that connects lower end portions of the side frames 21; the connecting frame 23 having a plate shape that spans right and left lower portions of the upper frame 22, and that extends in the seat width direction; and the rear frame 24 having a plate shape and attached to a rear surface of the upper frame 22.

In addition, the back frame 20 further includes right and left support wires 25 (occupant support wires) latched to the connecting frame 23 and the lower frame and extending in the up to down direction, and a support plate 26 (occupant support plate) having a substantially rectangular shape that is disposed at a central portion of the back frame 20, that is held by the right and left support wires 25, and that supports the seated occupant from behind.

Incidentally, the right and left side frames 21, the upper frame 22, and the lower frame correspond to a “frame-shaped body frame”.

The attachment bracket 27 for attaching the blower device 4 is further attached to the front surfaces of the connecting frame 23 and the rear frame 24.

In detail, a central portion of the connecting frame 23 in the seat width direction has a recessed shape recessed toward the rear of the seat. The rear frame 24 is disposed to cover substantially the entirety of the upper frame 22 and the connecting frame 23 from behind.

Furthermore, the attachment bracket 27 is attached to the front surface of the connecting frame 23 from the front of the seat in a state where the attachment bracket 27 is partially fitted, and is fixed to the connecting frame 23 and the rear frame 24 by a plurality of fastening bolts 28.

The attachment bracket 27 is interposed and disposed between the right and left pillars 31 and the rear frame 24 in the seat front to rear direction.

In addition, the plurality of fastening bolts 28 are disposed to surround the blower device 4 (blower body 4a) when viewed from the front of the seat.

As a result, the attachment rigidity of the blower device 4 can be increased.

A harness holding portion 24a for holding the harness 100 is formed at a lower end portion of the rear frame 24. In addition, a third harness attachment hole 24b (third harness attachment portion) for attaching a third attachment clip 103 (third attached portion) provided on the harness 100 is formed on a front surface of the harness holding portion 24a.

A plurality of the harness holding portions 24a hang down from the lower end portion of the rear frame 24, and are formed at intervals in the seat width direction.

With the above-described configuration, the harness 100 extending from the speakers 5 and the microphones 6 can be suitably held. In addition, interference of the harness 100 with other components can be suppressed.

Right and left pillar guides 29 for attaching the right and left pillars 31 serving as the core of the headrest 3 are assembled to an upper end portion of the upper frame 22. The pillar guides 29 are guide members that are fixed to the back frame 20, and that hold the pillars 31 so as to be movable in the up to down direction.

The right and left pillar guides 29 are disposed at a position overlapping the attachment bracket 27 in the seat front to rear direction, and are disposed at positions different from that of the attachment bracket 27 in the seat width direction.

For that reason, the design that suppresses interference between components while allowing the components to be compactly disposed is achieved.

As shown in FIG. 3 and FIGS. 5 to 7, the headrest frame 30 is mainly composed of the pillars 31 having an inverted U-shape and serving as the core of the headrest 3; a front cover 40 and the rear cover 50 assembled to the pillars 31 and disposed to interpose the pillars 31 in the seat front to rear direction; and a lower cover 60 disposed to cover the pillars 31 from below.

The front cover 40, the rear cover 50, and the lower cover 60 are disposed to cover the pillars 31, the speakers 5, the microphones 6, and the speaker assembly 70 from the outside, and are assembled to each other.

Incidentally, the front cover 40, the rear cover 50, and the lower cover 60 correspond to the “main body of the headrest”.

As shown in FIGS. 5, 6, and 8, the pillars 31 are support members having a tubular shape that support the main body of the headrest 3, are disposed at a predetermined interval in the seat width direction, and include right and left pillar extension portions 31a extending downward from the main body of the headrest 3 toward the seat back 2, and a pillar connecting portion 31b that connects upper end portions of the right and left pillar extension portions 31a, and that extends in the seat width direction.

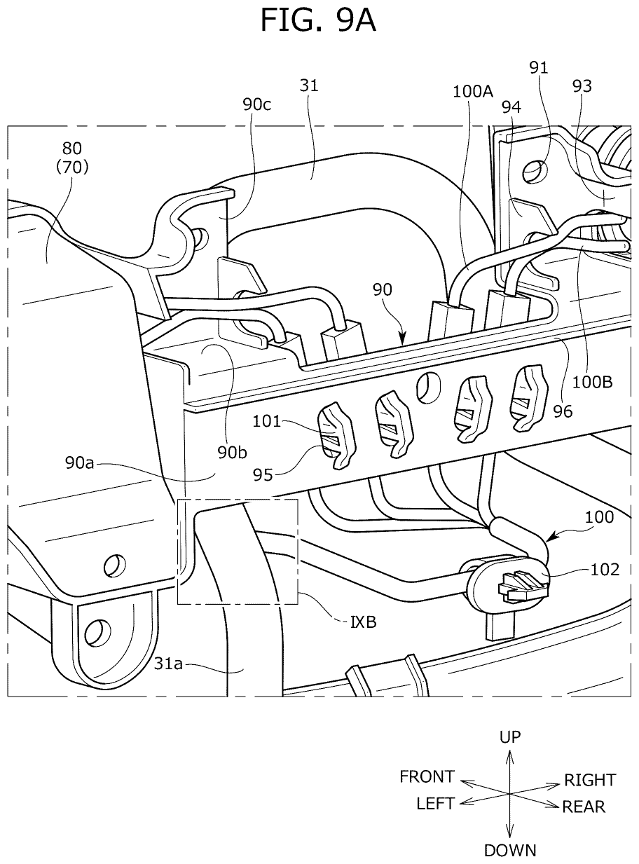

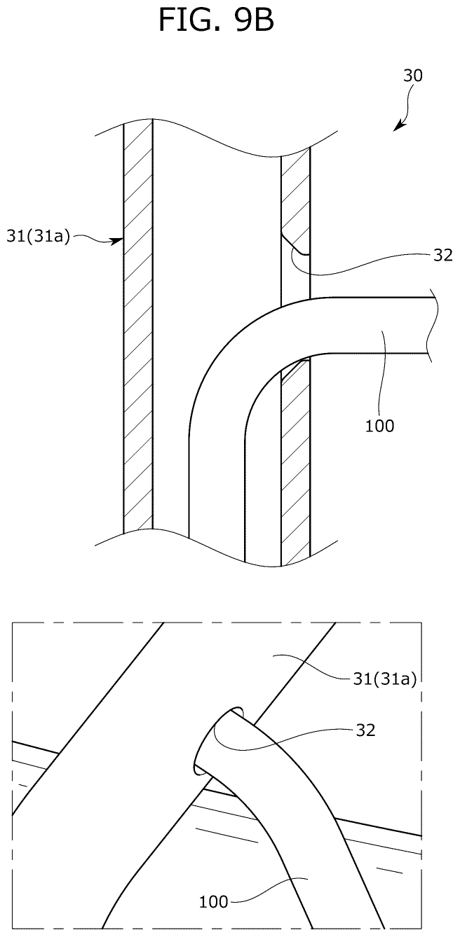

As shown in FIGS. 9A and 9B, a harness insertion hole 32 for passing the harness 100 is formed on an outer peripheral surface of the pillar 31 (left pillar extension portion 31a).

The harness insertion hole 32 is formed on an inner surface of the pillar extension portion 31a in the seat width direction, and has a reverse tapered cross-sectional shape.

For that reason, the harness can be easily inserted through the pillar. In addition, unintentional deformation of the harness can be suppressed.

Incidentally, the cross-sectional shape of the harness insertion hole 32 may be a tapered shape or a linear shape.

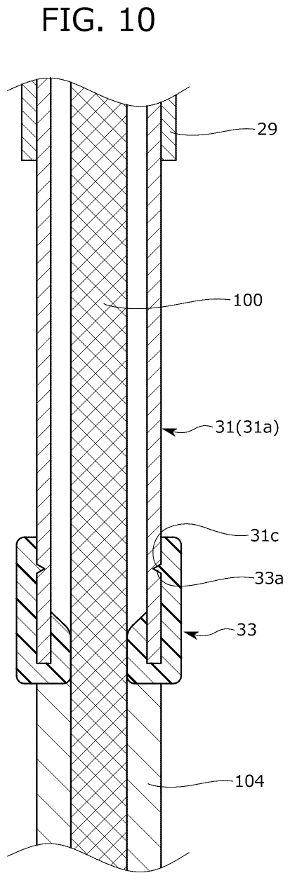

As shown in FIGS. 3 and 10, a cap member 33 having a tubular shape and having more flexibility than the pillar 31 made of metal is attached to a lower end portion of the pillar 31 (left pillar extension portions 31a).

The cap member 33 is also referred to as a pillar end cap, and is, for example, a cap made of rubber that is detachably attached to the lower end portion of the pillar 31 from below.

The cap member 33 includes a support projection 33a that is formed on an inner peripheral surface of the cap member 33, and that can be latched into a support groove 31c provided on the outer peripheral surface of the pillar 31.

The cap member 33 is attached to cover an end surface, an inner surface, and an outer surface of the lower end portion of the pillar 31 in a state where the cap member 33 is latched into the support groove 31c by the support projection 33a.

For that reason, when the harness 100 is exposed from the lower end portion of the pillar 31, the harness 100 can be protected by the cap member 33.

### Front Cover

As shown in FIG. 3 and FIGS. 5 to 7, the front cover 40 is a cover made of resin, and is assembled integrally with the rear cover 50 and the lower cover 60.

In detail, the front cover 40 is assembled to the rear cover 50 in the seat front to rear direction, and then is assembled to the lower cover 60 in the up to down direction.

The front cover 40 is a plate body including a front wall portion 40a, an upper wall portion 40b, right and left side wall portions 40c, and a bottom wall portion 40d.

In addition, the front cover 40 includes a cover central portion 41 provided at a central portion of the front cover 40 in the seat width direction, and right and left cover side portions 42 disposed outward to the right and left of the cover central portion 41, and protruding further toward the front of the seat than the cover central portion 41.

Locking pieces 43 and locking holes 43a that protrude toward the rear of the seat and that can be locked to the rear cover 50 (locking pawls 55) are formed at an upper end portion and both right and left end portions of an outer edge of the front cover 40.

A first pillar latching recess 44 that protrudes toward the rear of the seat and that can be assembled to the rear cover 50 (first pillar latching clip 56) is formed at an upper end portion of a rear surface of the front cover 40. In addition, right and left second pillar latching recesses 45 that can be assembled to the rear cover 50 (right and left second pillar latching clips 57) are formed at a rear end portion of a bottom surface of the front cover 40.

Right and left assembly bosses 46 (assembly portions) that are provided to be recessed toward the rear of the seat and that can be assembled to the rear cover 50 (assembly holes 58) are formed at a lower portion of a front surface of the front cover 40.

With the above-described configuration, the front cover 40 is provisionally fixed to the rear cover 50 by detachably locking the locking pieces 43 (locking holes 43a) to the locking pawls 55, and detachably latching the pillar latching recesses 44 and 45 to the pillar latching clips 56 and 57.

Then, the front cover 40 is fully fixed to the rear cover 50 by bolt-assembling the assembly bosses 46 into the assembly holes 58.

An engagement hole 47 that is provided to penetrate through the bottom surface of the front cover 40 in the up to down direction and that can be assembled to the lower cover 60 (engagement hook 62) is formed on the bottom surface of the front cover 40.

Fixing holes 48 (fixing portions) formed to protrude downward and fixed to the lower cover 60 (fixing bosses 63) are formed in a lower end portion of the front cover 40.

With the above-described configuration, the front cover 40 is provisionally fixed to the lower cover 60 by detachably engaging the engagement hole 47 with the engagement hook 62.

Then, the front cover 40 is integrally fixed to the lower cover 60 by bolt-fixing the fixing bosses 63 and the fixing holes 48 to each other in a state where the fixing bosses 63 are in contact with the fixing holes 48.

In detail, the fixing bosses 63 are brought into contact with the fixing holes 48 of the front cover 40 and fixing holes 59 of the rear cover 50 in a state where the fixing holes 48 and the fixing holes 59 are overlapped similarly to matching halves. Thereafter, the front cover 40, the rear cover 50, and the lower cover 60 are fully fixed by bolt-fixing the front cover 40, the rear cover 50, and the lower cover 60 to each other.

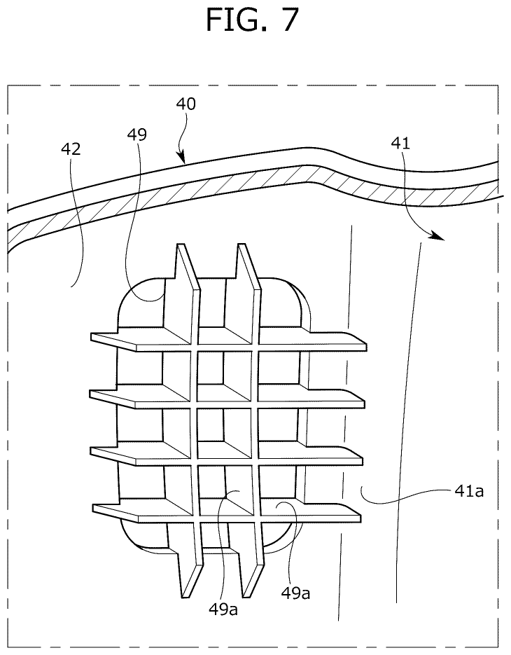

As shown in FIGS. 3 and 7, the right and left cover side portions 42 include opening portions 49 having a lattice shape and formed at positions corresponding to the right and left speakers 5 in the seat front to rear direction.

The opening portions 49 are also referred to as speaker grilles, and have a plurality of passage holes for passing sound output from the speakers 5.

Incidentally, the opening portions 49 are not particularly limited to being formed in a lattice shape, and may be formed in a net shape, and the shape is not particularly limited as long as the shape allows sound to pass therethrough.

As shown in FIG. 7, reinforcing ribs 49a formed along a lattice-shaped frame are formed on a rear surface of each of the opening portions 49.

The reinforcing ribs 49a extend in the seat width direction and the up to down direction. The reinforcing ribs 49a extending in the seat width direction are connected to a wall portion 41a (partition wall portion) between the cover central portion 41 and the cover side portion 42.

### Rear Cover

As shown in FIGS. 5, 6, and 8, the rear cover 50 is a cover made of resin, and is assembled integrally with the front cover 40 and the lower cover 60.

The rear cover 50 is assembled to the front cover 40 in the seat front to rear direction, and then is assembled to the lower cover 60 in the up to down direction.

The rear cover 50 is a plate body including a rear wall portion 50a, an upper wall portion 50b, right and left side wall portions 50c, and a bottom wall portion 50d.

Right and left attachment bosses 51 (attachment portions) that protrude toward the front of the seat and that can be attached to the speaker assembly 70 (right and left cover attachment holes 91) are formed at an upper end portion of a front surface of the rear cover 50. In addition, right and left second attachment bosses 52 (second attachment portions) that can be attached to the speaker assembly 70 (right and left second cover attachment holes 85) are formed at a lower end portion of the front surface of the rear cover 50. Further, a third attachment boss 53 (third attachment portion) that can be attached to the speaker assembly 70 (third cover attachment hole 92) is formed at a central portion of the front surface of the rear cover 50.

The right and left second attachment bosses 52 are disposed outside the right and left attachment bosses 51 in the seat width direction. The third attachment boss 53 is disposed inside the right and left attachment bosses 51.

With the above-described configuration, the speaker assembly 70 is attached to the front surface of the rear cover 50.

In detail, the speaker assembly 70 (third cover attachment hole 92) is provisionally fixed to the rear cover 50 (third attachment boss 53). Then, the cover attachment holes 91 and 85 are fully fixed to the attachment bosses 51 and 52 using attachment bolts.

A second harness attachment hole 54 for attaching the harness 100 (second attachment clip 102) is formed in the lower end portion of the front surface of the rear cover 50.

As a result, the harness 100 can be suitably held by the rear cover 50.

The locking pawls 55 (locking portions) that protrude toward the front of the seat and that can be locked to the front cover 40 (locking pieces 43) are formed at an upper end portion and both right and left end portions of an outer edge of the rear cover 50.

The first pillar latching clip 56 (first pillar latching portion) that protrudes toward the front of the seat and that can be assembled to the front cover 40 (first pillar latching recess 44) is formed at the upper end portion of the front surface of the rear cover 50. In addition, the right and left second pillar latching clips 57 (second pillar latching portions) that can be assembled to the front cover 40 (second pillar latching recesses 45) are formed at a front end portion of a bottom surface of the rear cover 50.

The right and left assembly holes 58 (assembled portions) that are provided to be recessed toward the rear of the seat and that can be assembled to the front cover 40 (right and left assembly bosses 46) are formed in the lower portion of the front surface of the rear cover 50.

The pillar latching clip 56 is disposed at a position overlapping with the right and left attachment bosses 51 in the up to down direction.

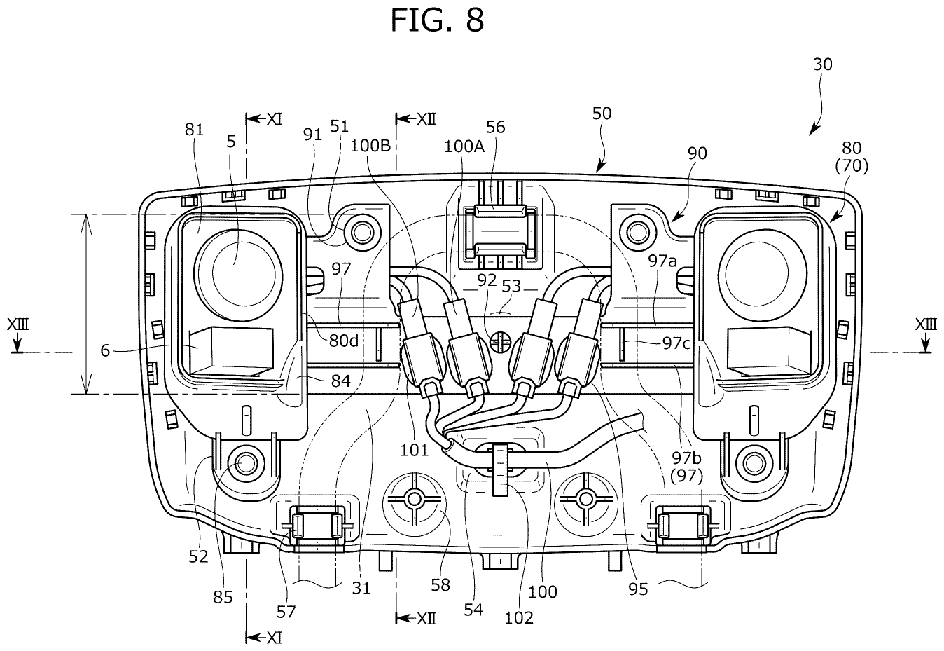

As shown in FIG. 8, the pillar latching clips 56 and 57 are disposed at positions where the pillar latching clips 56 and 57 interpose the right and left second attachment bosses 52 and the third attachment boss 53 therebetween in the up to down direction.

The pillar latching clip 56 is disposed between the right and left attachment bosses 51 and 52 in the seat width direction.

The second pillar latching clips 57 are disposed between the right and left attachment bosses 52 in the seat width direction.

The first pillar latching clip 56 is formed to clamp the pillar 31 in the up to down direction, and the second pillar latching clips 57 are formed to clamp the pillar 31 in the seat width direction.

With the above-described configuration, the pillar 31 and the front cover 40 are assembled to the front surface of the rear cover 50.

In detail, first, the pillar 31 is latched to the rear cover 50 (pillar latching clips 56 and 57). Then, the front cover 40 (the locking pieces 43 and the pillar latching recesses 44 and 45) is locked to the rear cover 50 (the locking pawls 55 and the pillar latching clips 56 and 57). Then, the front cover 40 (assembly bosses 46) is bolt-assembled to the rear cover 50 (assembly holes 58).

Incidentally, the pillar 31 is clamped between the front cover 40 (pillar latching recesses 44 and 45) and the rear cover 50 (pillar latching clips 56 and 57) in the seat front to rear direction.

In the above-described configuration, as shown in FIG. 8, when the pillar 31 is latched to the pillar latching clips 56 and 57, gap filling members 34 for filling gaps formed between the pillar 31 and the pillar latching clips 56 and 57 are attached to the gaps.

The gap filling members 34 are members having flexibility (elasticity). The looseness of the pillar 31 or the rear cover 50 can be suppressed by interposing the gap filling members 34 in the gaps. In addition, the generation of abnormal noise between the pillar 31 and the rear cover 50 can be suppressed.

Incidentally, the gap filling members 34 may be nonwoven fabrics, or may be dowels, grains, or ribs formed on an outer periphery of the pillar 31 or an outer surface of the rear cover 50.

The fixing holes 59 (fixing portions) formed to protrude downward and fixed to the lower cover 60 (fixing bosses 63) are formed in a lower end portion of the rear cover 50.

With the above-described configuration, the rear cover 50 is fixed to the lower cover 60 by bolt-fixing the fixing bosses 63 and the fixing holes 59 to each other in a state where the fixing bosses 63 are in contact with the fixing holes 59.

### Lower Cover

As shown in FIGS. 3, 5, and 6, the lower cover 60 is a cover made of resin, is assembled integrally with the front cover 40 and the rear cover 50, and is disposed to cover the front cover 40 and the rear cover 50 from below.

The lower cover 60 is a plate body having a curved shape that is curved downward. Specifically, an outer edge portion of the lower cover 60 is formed to project upward.

Right and left pillar insertion holes 61 (pillar insertion portions) for passing the pillar 31 (right and left pillar extension portions 31a) are formed in right and left side portions of an upper surface of the lower cover 60.

As a result, the lower cover 60 can be assembled to the pillar 31 latched to the rear cover 50.

The engagement hook 62 that protrudes upward and that can detachably engage with the front cover 40 (engagement hole 47) is formed at a central portion of the upper surface of the lower cover 60.

A plurality of the fixing bosses 63 (fixed portions) that protrude upward and that can be fixed to the front cover 40 (fixing holes 48) and the rear cover 50 (fixing holes 59) are formed on the upper surface of the lower cover 60.

The fixing bosses 63 are disposed at intervals in the seat width direction to interpose the engagement hook 62 therebetween.

With the above-described configuration, the lower cover 60 is provisionally fixed to the front cover 40, and then is bolt-fixed to the front cover 40 and the rear cover 50.

### Speaker Assembly

As shown in FIGS. 5, 6, 8, and 9A, the speaker assembly 70 is a box (housing) made of resin, and includes right and left speaker holding portions 80 that are provided at right and left side portions of the headrest 3, and that hold the right and left speakers 5 (microphones 6) in a state where the right and left speakers 5 (microphones 6) are exposed on the seat front side, and a connecting portion 90 that connects the right and left speaker holding portions 80, and that is formed integrally with the right and left speaker holding portions 80.

The term “being integrally formed” includes a state where the speaker holding portions 80 and the connecting portion 90 are integrated by welding or the like, in addition to the speaker holding portions 80 and the connecting portion 90 being integrally molded. Further, the term “being integrally formed” includes a state where the speaker holding portions 80 and the connecting portion 90 are assembled to each other without the need for separate attachment members (attachment plates, attachment bolts, and the like).

The speaker assembly 70 is disposed such that the right and left speaker holding portions 80 cover the pillar 31 from both sides in the seat width direction and the connecting portion 90 covers the pillar 31 from a seat rear side.

As a result, for example, during traveling of a conveyance, the shaking (movement) of the speaker assembly 70 and the speakers 5 in a right to left direction and the front to rear direction with respect to the headrest 3 (pillar 31) can be suppressed.

### Speaker Holding Portion

As shown in FIGS. 5, 6, and 8, the speaker holding portion 80 has the function of accommodating the speaker 5 and the microphone 6, and the function of accommodating the harnesses 100 connected to each of the speaker 5 and the microphone 6.

The speaker holding portion 80 has a central wall portion 80a; protruding wall portions (an upper wall portion 80b, a bottom wall portion 80c, and a side wall portion 80d) protruding from an outer edge portion of the central wall portion 80a toward the front of the seat; and extending wall portions (a rear upper wall portion 80e, a rear bottom wall portion 80f, and right and left rear side wall portions 80g) extending from the outer edge portion of the central wall portion 80a toward the rear of the seat.

In addition, the speaker holding portion 80 further includes second extending wall portions (a lower front wall portion 80h, a flange wall portion 80i, and a reinforcing wall portion 80j) extending downward from the rear bottom wall portion 80f.

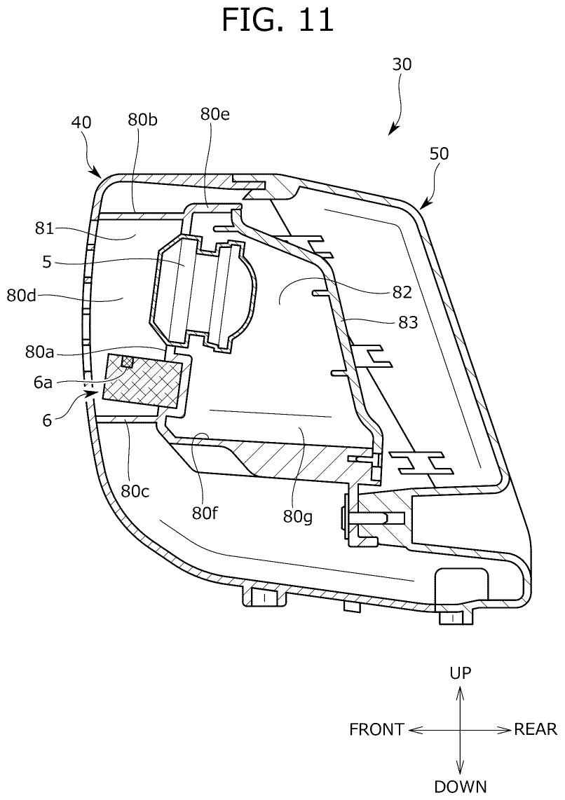

In the above-described configuration, as shown in FIGS. 5 and 11, the upper wall portion 80b protrudes forward from an upper end portion of a main body (central wall portion 80a) of the speaker holding portion 80. The bottom wall portion 80c protrudes forward from a lower end portion of the central wall portion 80a. The side wall portion 80d protrudes forward from a side end portion (right end portion) of the central wall portion 80a. Furthermore, a front end portion of each of the upper wall portion 80b, the bottom wall portion 80c, and the side wall portion 80d is in contact with the rear surface of the front cover 40.

As a result, when an external load is applied from the seat front side, the front cover 40 can be suitably supported by the speaker assembly 70.

Incidentally, the wall portions 80b, 80c, and 80d may not necessarily be in contact with the front cover 40, and may be disposed to be able to come into contact with the front cover 40.

As shown in FIGS. 5, 6, and 8, the speaker holding portion 80 includes an accommodation recess 81 that is provided at a front position of the speaker holding portion 80, and that accommodates the speaker 5 and the microphone 6; a rear accommodation recess 82 that is provided at a rear position of the speaker holding portion 80, and that accommodates the harness 100; and a lid portion 83 that covers the rear accommodation recess 82 from the rear of the seat.

The speaker 5 and the microphone 6 are accommodated in the accommodation recess 81 from the seat front side, and are held in a state where the speaker 5 and the microphone 6 are exposed on the seat front side.

In detail, the speaker 5 is accommodated to penetrate through an accommodation bottom surface of the accommodation recess 81, and is held in a state where the speaker 5 is exposed from the speaker holding portion 80 to the seat front side and the seat rear side. The microphone 6 is accommodated in a recessed portion 81a provided on the accommodation bottom surface of the accommodation recess 81, and is held in a state where the microphone 6 is exposed from the speaker holding portion 80 to the seat front side.

In more detail, the speaker 5 penetrates through the accommodation bottom surface of the accommodation recess 81 and an accommodation bottom surface of the rear accommodation recess 82 in the seat front to rear direction. Namely, the speaker 5 can also be rephrased as being accommodated in the accommodation recess 81 and the rear accommodation recess 82.

As shown in FIGS. 8 and 11, the speaker holding portion 80 holds the speaker 5 in a state where the speaker 5 is exposed to the seat front side, and holds the microphone 6 at a position below the speaker 5 in a state where the microphone 6 is exposed to the seat front side.

In addition, the speaker 5 and the microphone 6 are disposed between an upper end portion of the attachment boss 51 and a lower end portion of the connecting portion 90 in the up to down direction.

As a result, the rear cover 50, the speaker assembly 70, the speaker 5, and the microphone 6 can be firmly attached to the pillar 31 serving as the core of the headrest 3.

The harness 100A connected to the speaker 5 and the harness 100B connected to the microphone 6 are accommodated in the rear accommodation recess 82. Then, the rear accommodation recess 82 is covered from the rear of the seat by the lid portion 83.

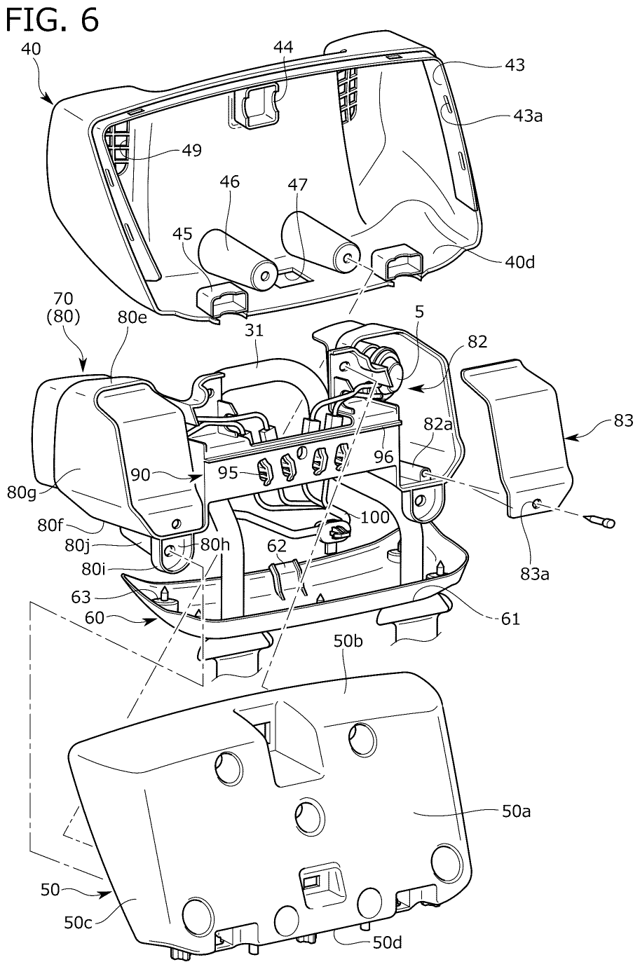

In detail, as shown in FIG. 6, bolt holes 82a and 83a are formed in a lower end portion of the rear accommodation recess 82 and a lower end portion of the lid portion 83, respectively. The lid portion 83 is attached to the rear accommodation recess 82 by attaching a fixing bolt to the bolt holes 82a and 83a in a state where the bolt holes 82a and 83a communicate with each other.

Incidentally, as shown in FIGS. 6 and 9A, extension end portions of the harnesses 100A and 100B extend to protrude inward in the seat width direction from gaps formed on an inner surface of the rear accommodation recess 82.

In the above-described configuration, as shown in FIG. 8, a depression portion 84 is formed at a corner (corner of an inner lower end portion) of the accommodation recess 81.

As a result, the rigidity of the accommodation recess 81 can be increased. In addition, interference between the accommodation recess 81 and other components can be suppressed.

In the above-described configuration, as shown in FIGS. 5 and 8, the right and left second cover attachment holes 85 that can be attached to the rear cover 50 (right and left second attachment bosses 52) are formed in lower end portions of the speaker holding portions 80.

The second cover attachment holes 85 are disposed at positions directly below the speakers 5 and the microphones 6. In addition, the second cover attachment holes 85 are disposed at positions outside the pillar 31 in the seat width direction.

In the above-described configuration, as shown in FIGS. 5 and 11, the microphone 6 is disposed at a position below the speaker 5, and is disposed to protrude further toward the front side than the speaker 5. The microphone 6 is accommodated in the accommodation recess 81 such that a sound collection portion 6a of the microphone 6 faces upward toward the speaker 5.

For that reason, sound output by the speaker 5 can be suitably collected by the microphone 6.

In the above-described configuration, as shown in FIGS. 5 and 8, the right and left microphones 6 protrude further forward than the right and left speakers 5. Furthermore, the right and left microphones 6 are disposed at positions closer to the outside in the seat width direction than the right and left speakers 5.

For that reason, the front cover 40 (cover side portions 42) can suitably support the head of the seated occupant (discomfort felt by the seated occupant due to the microphones 6 is suppressed).

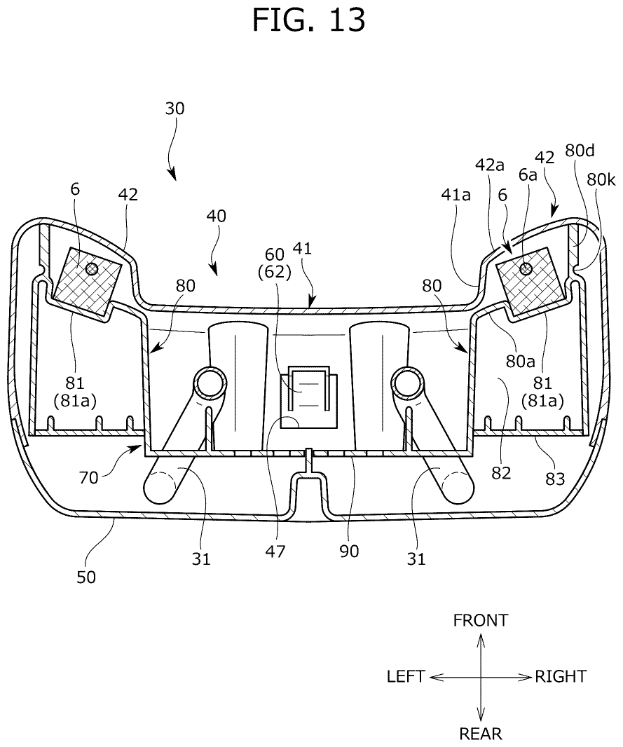

In the above-described configuration, as shown in FIG. 13, the partition wall portion 41a between the cover central portion 41 and each of the cover side portions 42 is disposed at a position overlapping the microphone 6 in the up to down direction and the front to rear direction.

For that reason, the microphones 6 can be suitably disposed in empty spaces of the cover side portions 42. Namely, an increase in the size of the headrest 3 (headrest frame 30) can be suppressed.

In the above-described configuration, as shown in FIG. 13, an overlapping portion 42a of the front cover 40, which overlaps the accommodation recess 81 in a front view, is disposed to incline inward in the seat width direction. A front surface of the accommodation recess 81 is disposed to incline in the same direction as the overlapping portion 42a of the front cover 40, and the microphone 6 is accommodated in the accommodation recess 81 in a state where the microphone 6 is inclined in the same direction as the front surface of the accommodation recess 81.

For that reason, interference between the microphone 6 and the front cover 40 can be suppressed. In addition, the microphone 6 can be suitably disposed to incline toward a seated occupant side.

In this case, it is preferable that the microphone 6 is accommodated in the accommodation recess 81 in a state where the microphone 6 is inclined further inward in the seat width direction than the front surface of the accommodation recess 81.

Incidentally, the overlapping portion 42a of the front cover 40 may be disposed to incline outward in the seat width direction. Alternatively, the front surface of the accommodation recess 81 and the microphone 6 may be disposed to incline outward in the seat width direction.

In the above-described configuration, as shown in FIGS. 5 and 13, the cover side portion 42 covers at least a part of the speaker holding portion 80 from the front and both sides in the seat width direction.

Specifically, the speaker holding portion 80 includes the central wall portion 80a forming the front surface of the accommodation recess 81, and the side wall portions 80d protruding forward from both end portions of the central wall portion 80a in the seat width direction. Furthermore, the cover side portion 42 covers at least the right and left side wall portions 80d of the speaker holding portion 80 from the front and both sides in the seat width direction.

For that reason, the speaker 5 and the microphone 6 accommodated in the accommodation recess 81 can be suitably covered. For example, sound output from the speakers can be suitably collected by the microphones.

In the above-described configuration, as shown in FIG. 5, the side wall portions 80d of the speaker holding portion 80 protrude forward from the central wall portion 80a, and cover exposed portions of the speaker 5 and the microphone 6 from the sides.

In this case, the side wall portions 80d have both an impact absorption function in the event of an external collision and an acoustic function.

For that reason, the speaker 5 or the microphone 6 can be protected from a load from the outside. In addition, the leakage of sound output from the speaker 5 can be suppressed. In addition, the sound collection performance of the microphone 6 can be improved.

In the above-described configuration, as shown in FIG. 5, in the speaker holding portion 80, the outer side wall portion 80d protrudes farther forward than the inner side wall portion 80d.

For that reason, the speaker 5 or the microphone 6 can be protected from loads from the front and the sides. In addition, the leakage of sound output from the speaker 5 to the outside in the seat width direction can be suppressed.

In the above-described configuration, as shown in FIG. 5, of the right and left side wall portions 80d of the speaker holding portion 80, the inner side wall portion 80d is disposed at the same height position in the up to down direction as the speaker 5.

For that reason, the speaker 5 can be protected by the inner side wall portion 80d.

In the above-described configuration, as shown in FIG. 8, the depression portion 84 is formed at a corner (corner of the inner lower end portion) of the accommodation recess 81. The depression portion 84 is disposed at a position adjacent to the microphone 6.

For that reason, the amount of protrusion of the side wall portion 80d can be partially suppressed, and the side wall portion 80d can be reinforced by the depression portion 84.

In the above-described configuration, as shown in FIGS. 5 and 13, the side wall portion 80d (outer side wall portion 80d) of the speaker holding portion 80 is disposed in front of the speaker 5 and the microphone 6. In addition, the side wall portion 80d is disposed in front of the sound collection portion 6a of the microphone 6. In addition, the side wall portion 80d is disposed in front of a front end portion of the microphone 6.

For that reason, the speaker 5 and the microphone 6 can be suitably protected by the side wall portion 80d. In addition, the sound collection performance of the microphone 6 is increased by the side wall portion 80d. In addition, when a load is applied to the front cover 40, the microphone 6 can be protected by the side wall portion 80d.

In the above-described configuration, as shown in FIG. 13, a fragile portion 80k (thin portion) is formed at a base end portion of the side wall portion 80d of the speaker holding portion 80.

The fragile portion 80k is formed on one of both side surfaces of the side wall portion 80d, which is opposite to a microphone 6 side.

By forming the fragile portion 80k, when a load is applied from the outside (when a load is applied to the front cover 40 from the front), the side wall portion 80d can be suitably bent. Namely, the application of an excessive load to the speaker holding portion 80 can be suppressed.

In addition, by forming the fragile portion 80k on the outer side of the side wall portion 80d, the fragile portion 80k can be prevented from affecting the sound of the speaker 5.

In the above-described configuration, instead of the fragile portion 80k (thin portion), a reinforcing portion (reinforcing rib) may be formed at the base end portion of the side wall portion 80d of the speaker holding portion 80.

The reinforcing portion is formed on one of both the side surfaces of the side wall portion 80d, which is opposite to the microphone 6 side.

By forming the reinforcing portion, when a load is applied from the outside (when a load is applied to the front cover 40 from the front), the rigidity of the side wall portion 80d can be increased.

In addition, by forming the reinforcing portion on the outer side of the side wall portion 80d, the influence on the sound of the speaker 5 can be suppressed.

### Connecting Portion

As shown in FIGS. 5, 6, 8, and 9A, the connecting portion 90 is a connecting bracket that is long in the seat width direction, is a portion for assembling the speaker assembly 70 to the pillar 31, and is a portion that holds the harness 100 extending from the speakers 5 (microphones 6).

The connecting portion 90 includes a rear wall portion 90a that extends longitudinally in the seat width direction, and that connects the right and left speaker holding portions 80; an upper wall portion 90b extending from an upper end portion of the rear wall portion 90a toward the front of the seat; and a front wall portion 90c extending upward from a front end portion of the upper wall portion 90b.

The right and left cover attachment holes 91 that can be attached to the rear cover 50 (right and left attachment bosses 51) are formed in an upper end portion of the connecting portion 90 (front wall portion 90c).

In addition, the third cover attachment hole 92 that can be attached to the rear cover 50 (third attachment boss 53) is formed in a central portion of the connecting portion (rear wall portion 90a).

Harness guide portions 93 and 94 that are formed to protrude toward the rear of the seat and that guide the harness 100 are formed on a rear surface of the connecting portion 90 (front wall portion 90c).

The harness guide portion 93 and the second harness guide portion 94 are disposed side by side in the seat width direction, and are disposed at positions facing the rear accommodation recess 82.

The harness guide portions 93 and 94 have a U-shape, and support the harness 100 from above, below, and the front after the harness 100 is attached from the rear of the seat.

As shown in FIGS. 8 and 9A, a plurality of harness attachment holes 95 for attaching attachment clips 101 that are provided on the harness 100 to support the harness 100 are formed on a front surface of the central portion of the connecting portion 90 (rear wall portion 90a).

In addition, as shown in FIG. 9A, a reinforcing rib 96 that extends longitudinally along an extending direction of the connecting portion 90 is formed on the rear surface of the connecting portion 90 (rear wall portion 90a) at a position above the harness attachment holes 95.

In addition, as shown in FIGS. 5, 8, and 12, contact ribs 97 that protrude to the front of the seat toward the pillar 31 and that come into contact with a rear surface of the pillar 31 are formed on front surfaces of right and left side portions of the connecting portion 90 (rear wall portion 90a).

As shown in FIGS. 8 and 9A, the plurality of harness attachment holes 95 are disposed side by side in the seat width direction.

The reinforcing rib 96 extends further outward to the right and left than the plurality of harness attachment holes 95 in the seat width direction, and protrudes toward an opposite side (seat rear side) to a harness 100 side (seat front side).

For that reason, when the reinforcing rib 96 is formed around the harness attachment holes 95, the reinforcing rib can be disposed while suppressing interference between the harness 100 and the reinforcing rib 96.

As shown in FIG. 8, the contact ribs 97 are formed on the right and left at a predetermined interval in the seat width direction.

The right and left contact ribs 97 are disposed to interpose the harness attachment holes 95 therebetween.

In detail, each of the contact ribs 97 includes a first contact rib 97a and a second contact rib 97b disposed at an interval in the up to down direction, and a connecting rib 97c that connects the first contact rib 97a and the second contact rib 97b.

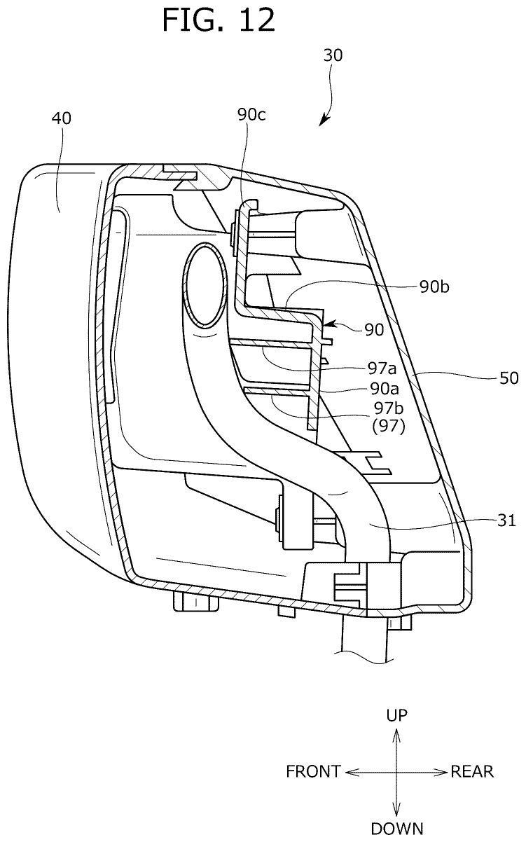

Furthermore, as shown in FIG. 12, each of the first contact rib 97a, the second contact rib 97b, and the connecting rib 97c is in contact with the rear surface of the pillar 31.

Incidentally, the contact ribs 97 may not necessarily be in contact with the pillar 31, and may be disposed to be able to come into contact with the pillar 31.

### Harness

As shown in FIG. 6 and FIGS. 8 to 10, the harnesses 100A and 100B extend inward in the seat width direction from the speakers 5 and the microphones 6, respectively, and are bundled into the single harness 100, and the harness 100 passes through the inside of the pillar 31 (left pillar 31), and extends downward toward the seat back 2. Then, the harness 100 extends further from the seat back 2 toward the seat cushion 1, and is connected to the control device 7 provided in the seat cushion 1.

The harnesses 100A and 100B each include the attachment clips 101 that can be attached to the speaker assembly 70 (harness attachment holes 95). In detail, the harnesses 100A and 100B include couplers at positions facing the harness attachment holes 95, and include the attachment clips 101 provided on the couplers.

In addition, the harness 100 includes the second attachment clip 102 that can be attached to the rear cover 50 (second harness attachment hole 54).

In addition, the harness 100 includes the third attachment clip 103 that is provided inside the seat back 2, and that can be attached to the rear frame 24 (third harness attachment hole 24b).

In addition, the harness 100 includes a harness guide 104 that is provided inside the seat back 2, and that covers the harness 100 (harness body).

Hereinafter, a routing of the harness 100 will be described in detail with reference to FIGS. 3 and 6 and FIGS. 8 to 10.

The harnesses 100A (100B) are connected to the speakers 5 (microphones 6), and are accommodated in the rear accommodation recesses 82.

The harnesses 100A extending from the speakers 5 extend inward in the seat width direction from the rear accommodation recesses 82, and are supported by the harness guide portions 93 and 94.

Then, the harnesses 100A extend downward from the harness guide portions 93 and 94, and are supported by the harness attachment holes 95. Specifically, the attachment clips 101 are attached to the harness attachment holes 95.

Then, the harnesses 100A and the harnesses 100B extend downward and are bundled into the single harness 100.

The single bundled harness 100 is supported by the second harness attachment hole 54. Specifically, the second attachment clip 102 is attached to the rear cover 50 (second harness attachment hole 54).

Then, the harness 100 extends from the second harness attachment hole 54 to one side (left side) in the seat width direction toward the pillar 31 (left pillar extension portions 31a).

Then, the harness 100 passes through the inside of the pillar 31 via the harness insertion hole 32 provided in the pillar 31, and extends downward toward the seat back.

The harness 100 exposed from the lower end portion of the pillar 31 first extends toward the right side in the seat width direction, then is folded back, and extends toward the left side in the seat width direction along the lower end portion of the rear frame 24.

In this case, the harness 100 is held by the plurality of harness holding portions 24a located at the lower end portion of the rear frame 24. In addition, the harness 100 is supported by the third harness attachment hole 24b located at the lower end portion of the rear frame 24. Specifically, the third attachment clip 103 is attached to the third harness attachment hole 24b.

Inside the seat back 2, the harness 100 and the blower harness 4d are bundled into a single harness, and the single harness extends downward toward the seat cushion 1.

Then, the single bundled harness 100 is connected to the control device 7 provided inside the seat cushion 1.

In the above-described configuration, as shown in FIG. 9A, the harnesses 100A and 100B extend from the speaker 5 and the microphone 6, respectively. Measures may be taken to prevent the incorrect assembly of the harnesses 100A and 100B.

For example, the thickness of the harness 100A connected to the speaker 5 and the thickness of the harness 100B connected to the microphone 6 may be changed. Namely, the thickness of the harness 100A may be made thicker than the thickness of the harness 100B. Alternatively, the thickness of the harness 100A may be made thinner than the thickness of the harness 100B.

In addition, for example, a coupler (connector) of the harness 100A and a coupler (connector) of the harness 100B may be made in different shapes, different sizes, different colors, or with different marks. As the different marks, a mark “S (speaker)” may be attached to the harness 100A, and a mark “M (microfone)” may be attached to the harness 100B.

In the above-described configuration, as shown in FIGS. 9A and 9B, the right and left harnesses 100 are bundled into a single harness, and the single harness is passed through the inside of the left pillar 31.

Meanwhile, as a modification example, the harness 100 connected to the left speaker 5 may extend from the left speaker toward the pillar 31, and may pass through the inside of the pillar 31 via the harness insertion hole 32 provided in the left pillar extension portions 31a. Furthermore, the harness 100 connected to the right speaker 5 may pass through the inside of the pillar 31 via the harness insertion hole 32 provided in the right pillar extension portions 31a.

In the above-described configuration, as shown in FIGS. 8 and 9A, the speaker harness 100A and the microphone harness 100B are assembled separately from each other.

For that reason, the generation of noise in the speaker harness 100A due to the influence of a magnetic field generated by the microphone harness 100B can be suppressed.

In the above-described configuration, it is preferable that the speaker harness 100A and the microphone harness 100B are disposed to be perpendicular to each other. For example, it is preferable that the speaker harness 100A and the microphone harness 100B are disposed such that a part of the speaker harness 100A and a part of the microphone harness 100B are perpendicular to each other at a position near the speaker 5 and the microphone 6.

As a result, the influence of magnetic fields on each other can be suppressed.

### Method for Manufacturing Conveyance Seat

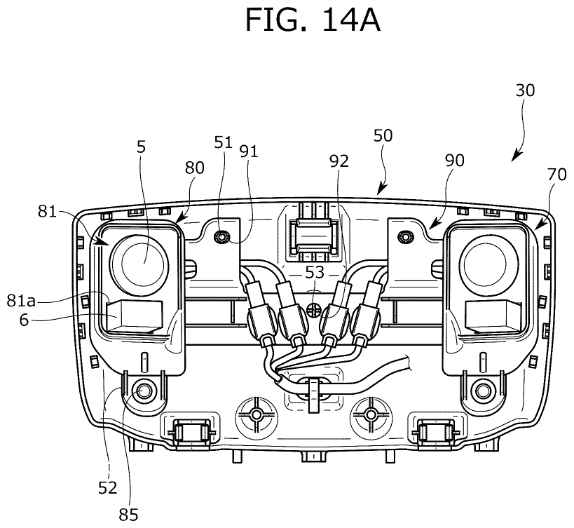

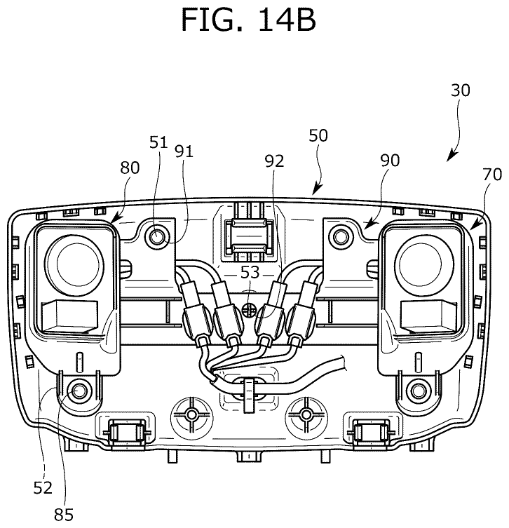

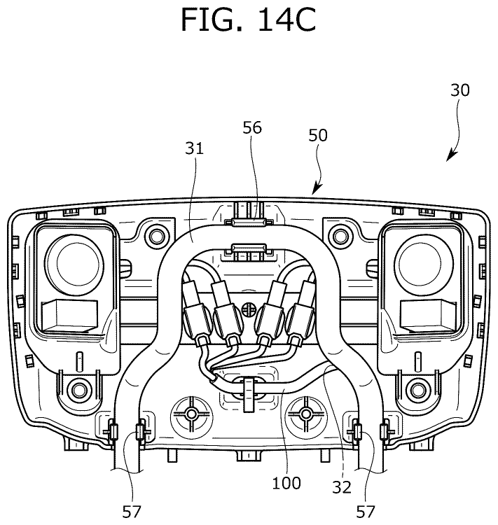

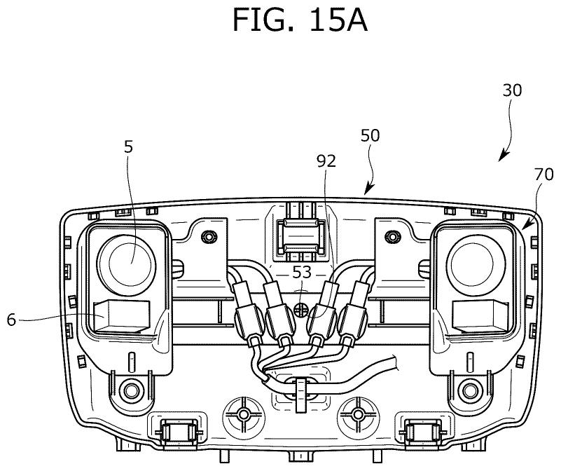

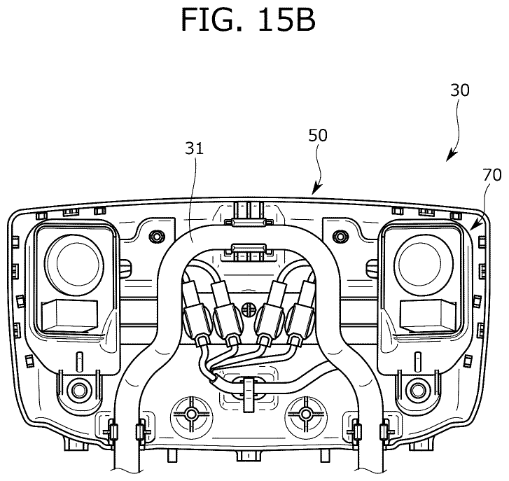

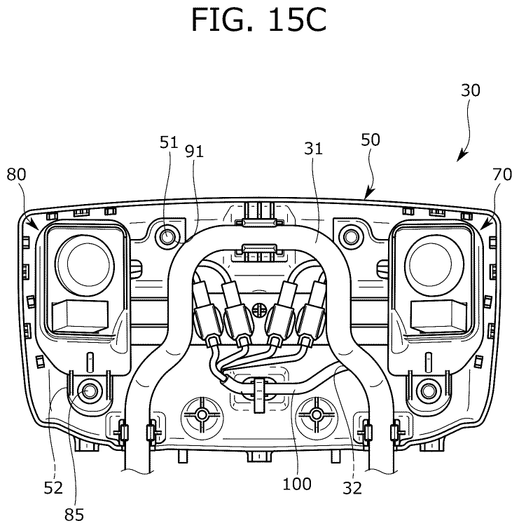

Next, methods 1 and 2 for manufacturing the conveyance seat S will be described with reference to FIGS. 14A to 14C and FIGS. 15A to 15C.

Incidentally, regarding the methods for manufacturing the conveyance seat S, a description of manufacturing steps other than those to be described below will be omitted.

In the “manufacturing method 1”, as shown in FIGS. 14A to 14C, first, the speakers 5 and the microphones 6 are assembled to the speaker assembly 70. Specifically, the speakers 5 are assembled to the speaker holding portions 80 (accommodation recesses 81), and are fixed thereto using an adhesive or assembly bolts. In addition, the microphones 6 are assembled to the recessed portions 81a.

Then, the speaker assembly 70 is attached to the rear cover 50. Specifically, the cover attachment holes 91, 85, and 92 are attached to the right and left attachment bosses 51, 52, and 53. More specifically, the cover attachment holes 91 and 85 are bolt-fixed to the attachment bosses 51 and 52. Incidentally, the third cover attachment hole 92 is latched and provisionally fixed to the third attachment boss 53.

Then, the pillar 31 is latched to the rear cover 50. Specifically, the pillar 31 is latched to the pillar latching clips 56 and 57.

Then, the harness 100 is passed through the inside of the pillar 31.

Then, the front cover 40 is assembled to the rear cover 50, and the lower cover 60 is assembled from below in a state where the front cover 40 and the rear cover 50 are assembled.

In the “manufacturing method 2”, as shown in FIGS. 15A to 15C, first, the speakers 5 and the microphones 6 are assembled to the speaker assembly 70.

Then, the speaker assembly 70 is “provisionally fixed” to the rear cover 50. Specifically, the third cover attachment hole 92 is latched and provisionally fixed to the third attachment boss 53.

Then, the pillar 31 is latched to the rear cover 50. In this case, the speaker assembly 70 is pressed against the rear cover 50 by the pillar 31.

Then, the speaker assembly 70 is “fully fixed” to the rear cover 50. Specifically, the cover attachment holes 91 and 85 are bolt-fixed to the attachment bosses 51 and 52.

Then, the harness 100 is passed through the inside of the pillar 31.

Then, the front cover 40 is assembled to the rear cover 50, and the lower cover 60 is assembled from below in a state where the front cover 40 and the rear cover 50 are assembled.

According to the above-described configuration, the conveyance seat S that allows the speakers 5 to be easily assembled to the headrest 3 can be realized.

In addition, the conveyance seat S in which the configuration of the speaker assembly 70 for assembling the speakers 5 can be more simplified than in the related art can be realized.

In addition, the method for manufacturing the conveyance seat S can be realized.

### Other Embodiments

In the above-described embodiment, as shown in FIG. 5, the headrest frame 30 includes the front cover 40, the rear cover 50, and the lower cover 60; however, the configuration is not particularly limited.

For example, the lower cover 60 may be eliminated. Alternatively, the front cover 40 or the rear cover 50 may be eliminated.

In the above-described embodiment, as shown in FIGS. 5 and 6, the engagement hole 47 of the front cover 40 and the engagement hook 62 of the lower cover 60 are engaged with each other; however, the engagement structure is not particularly limited.

For example, the engagement hole 47 may be changed to an engagement recess.

In addition, for example, the engagement structure may be changed to an engagement structure Other than the engagement hole and the engagement hook. Namely, an engaged portion of the front cover 40 and an engagement portion of the lower cover 60 may be engaged with each other by other engagement structures.

In addition, in the above-described embodiment, the structures of the locking portion and the locked portion, the structures of the attachment portion and the attached portion, the structures of the assembly portion and the assembled portion, the structures of the fixing portion and the fixed portion, and the like may be changed as appropriate.

In the above-described embodiment, as shown in FIGS. 5 and 6, the right and left speaker holding portions 80 and the connecting portion 90 are integrally formed in the speaker assembly 70; however, the configuration is not particularly limited.

The right and left speaker holding portions 80 and the connecting portion 90 may be formed separately. Namely, the speaker holding portions 80 and the connecting portion 90 may be connected to each other via an attachment member.

In the above-described embodiment, as shown in FIGS. 5 and 6, each speaker holding portion 80 includes the accommodation recess 81 and the rear accommodation recess 82, but may include only one of the accommodation recesses. For example, each speaker holding portion 80 may include only the rear accommodation recess 82 (accommodation recess), and may accommodate the speaker 5, the microphone 6, and the harness 100. In this case, it is preferable that the speaker 5 and the microphone 6 are disposed to penetrate through the accommodation bottom surface of the rear accommodation recess 82 and be exposed to the seat front side.

In the above-described embodiment, the conveyance seat used in automobiles has been described as a specific example; however, the present invention is not particularly limited, and can be used as conveyance seats for airplanes, ships, and the like in addition to conveyance seats for trains, buses, and the like.

In the present embodiment, the conveyance seat according to the present invention has been mainly described. However, the above-described embodiment is merely one example for easy understanding of the present invention, and does not limit the present invention. The present invention can be modified and improved without departing from the concept of the present invention, and it goes without saying that the present invention includes its equivalents.

### REFERENCE SIGNS LIST

S: conveyance seat
1: seat cushion
   1a, 2a: cushion material
   1b, 2b: skin material
2: seat back
3: headrest
   3a: cushion material
   3b: second cushion material
   3c: skin material
   3d: second skin material
4: blower device
   4a: blower body
   4b: duct
   4c: blower outlet
   4d: blower harness
5: speaker (speaker unit)
6: microphone (microphone unit)
   6a: sound collection portion
7: control device
10: cushion frame
20: back frame
21: side frame
22: upper frame
23: connecting frame
24: rear frame
   24a: harness holding portion
   24b: third harness attachment hole
25: support wire (occupant support wire)
26: support plate (occupant support plate)
27: attachment bracket
28: fastening bolt
29: pillar guide
30: headrest frame
31: pillar (headrest pillar)
   31a: pillar extension portion
   31b: pillar connecting portion
   31c: support groove
32: harness insertion hole
33: cap member
   33a: support projection
34: gap filling member
40: front cover
   40a: front wall portion
   40b: upper wall portion
   40c: side wall portion
   40d: bottom wall portion
41: cover central portion
   41a: partition wall portion (wall portion)
42: cover side portion
   42a: overlapping portion
43: locking piece (locked portion)
   43a: locking hole
44: first pillar latching recess (first pillar latched portion)
45: second pillar latching recess (second pillar latched portion)
46: assembly boss (assembly portion)
47: engagement hole (engaged portion, engagement recess)
48: fixing hole (fixing portion)
49: opening portion
   49a: reinforcing rib
50: rear cover
   50a: rear wall portion
   50b: upper wall portion
   50c: side wall portion
   50d: bottom wall portion
51: attachment boss (attachment portion)
52: second attachment boss (second attachment portion)
53: third attachment boss (third attachment portion)
54: second harness attachment (second harness attached portion)
55: locking pawl (locking portion)
56: first pillar latching clip (first pillar latching portion)
57: second pillar latching clip (second pillar latching portion)
58: assembly hole (assembled portion)
59: fixing hole (fixing portion)
60: lower cover
61: pillar insertion hole (pillar insertion portion)
62: engagement hook (engagement portion)
63: fixing boss (fixed portion)
70: speaker assembly
80: speaker holding portion
   80a: central wall portion (front surface of accommodation recess)
   80b: upper wall portion
   80c: bottom wall portion
   80d: side wall portion
   80e: rear upper wall portion
   80f: rear bottom wall portion
   80g: rear side wall portion
   80h: lower front wall portion
   80i: flange wall portion
   80j: reinforcing wall portion
   81: accommodation recess
81a: recessed portion
82: rear accommodation recess
   82a: bolt hole
83: lid portion
   83a: bolt hole
84: depression portion
85: second cover attachment hole (second cover attachment portion)
90: connecting portion
   90a: rear wall portion
   90b: upper wall portion
   90c: front wall portion
91: cover attachment hole (cover attachment portion)
92: third cover attachment hole (third cover attachment portion)
93: harness guide portion
94: second harness guide portion
95: harness attachment hole (harness attachment portion)
96: reinforcing rib
97: contact rib
   97a: first contact rib
   97b: second contact rib
   97c: connecting rib
100: harness
   100A: speaker harness
   100B: microphone harness
101: attachment clip (attached portion)
102: second attachment clip (second attached portion)
103: third attachment clip (second attached portion)
104: harness guide

1. A conveyance seat, comprising:
a headrest;
right and left speakers provided inside the headrest; and
right and left microphones provided inside the headrest,
wherein the microphones are disposed at positions below the speakers, and are disposed to protrude further toward a front side than the speakers, and
the microphones are disposed such that sound collection portions of the microphones face upward toward the speakers.

2. The conveyance seat according to claim 1,
wherein a front cover disposed to cover the right and left speakers and the right and left microphones from a front is provided, and
the right and left microphones are disposed at positions closer to an outside in a seat width direction than the right and left speakers.

3. The conveyance seat according to claim 1,
wherein a front cover disposed to cover the right and left speakers and the right and left microphones from a front is provided,
the front cover includes a cover central portion provided at a central portion of the front cover in a seat width direction, and right and left cover side portions disposed outside the cover central portion in the seat width direction, and protruding further forward than the cover central portion, and
a partition wall portion between the cover central portion and each of the cover side portions is disposed at a position overlapping the microphone in an up to down direction and a front to rear direction.

4. The conveyance seat according to claim 1,
wherein a pillar that supports a main body of the headrest, and a speaker assembly provided inside the headrest and configured to assemble the right and left speakers and the right and left microphones are provided,
the speaker assembly includes accommodation recesses for accommodating the microphones,
the accommodation recesses protrude further forward than the pillar, and
the microphones are disposed at positions closer to an outside in a seat width direction than the speakers.

5. The conveyance seat according to claim 1,
wherein a speaker assembly provided inside the headrest and configured to assemble the right and left speakers, and the right and left microphones and a front cover disposed to cover the right and left speakers, the right and left microphones, and the speaker assembly from a front are provided,
the speaker assembly includes right and left speaker holding portions that hold the right and left speakers and the right and left microphones, respectively, and a connecting portion that connects the right and left speaker holding portions,
each of the speaker holding portions includes an accommodation recess for accommodating the microphone,
an overlapping portion of the front cover that overlaps the accommodation recess in a front view is disposed to incline inward or outward in a seat width direction,
a front surface of the accommodation recess is disposed to incline in the same direction as the overlapping portion of the front cover, and
the microphone is accommodated in the accommodation recess in a state where the microphone is inclined in the same direction as the front surface of the accommodation recess.

6. The conveyance seat according to claim 5,
wherein the overlapping portion of the front cover is disposed to incline inward in the
seat width direction, the front surface of the accommodation recess is disposed to incline in the same direction as the overlapping portion of the front cover, and
the microphone is accommodated in the accommodation recess in a state where the microphone is inclined in the same direction as the front surface of the accommodation recess.

7. The conveyance seat according to claim 6,
wherein the microphone is accommodated in the accommodation recess in a state where the microphone is inclined further inward in the seat width direction than the front surface of the accommodation recess.

8. The conveyance seat according to claim 5,
wherein a recessed portion recessed rearward is formed on the front surface of the accommodation recess, and
a rear portion of the microphone is accommodated in the recessed portion.

9. The conveyance seat according to claim 5,
wherein the front cover includes a cover central portion provided at a central portion of the front cover in the seat width direction, and right and left cover side portions disposed outside the cover central portion in the seat width direction, and protruding further forward than the cover central portion, and
the cover side portions cover at least parts of the speaker holding portions from the front and both sides in the seat width direction.

10. The conveyance seat according to claim 9,
wherein each of the speaker holding portions includes a central wall portion forming the front surface of the accommodation recess, and a side wall portion protruding forward from an end portion of the central wall portion in the seat width direction, and
the cover side portions cover at least the side wall portions of the speaker holding portions from the front and both the sides in the seat width direction.
